(19) United States
(12) Patent Application Publication
(10) Pub. No.: US 2007/0064946 A1
(43) Pub. Date: Mar. 22, 2007

(54) Computer-readable recording medium recording a character code encryption program, and a character code encryption method

(75) Inventors: Shigeyuki Ohkubo, Shinagawa (JP); Ryota Akiyama, Shinagawa (JP); Toshihiro Suzuki, Shinagawa (JP); Yuji Miyamoto, Shinagawa (JP); Takaoki Sasaki, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU BROAD SOLUTION & CONSULTING INC., Tokyo (JP)

(21) Appl. No.: 11/290,791

(22) Filed: Dec. 1, 2005

(30) Foreign Application Priority Data
Aug. 31, 2005 (JP) 2005-250818

(51) Int. Cl. H04L 9/00

(52) U.S. Cl. 380/267

(57) ABSTRACT

A computer-readable recording medium recording a character code encryption program capable of encrypting character codes without changing the data length. When plaintext is input, a plaintext encoder converts character codes included in the plaintext to corresponding numerical values. Then, an encryptor successively acquires the numerical values of the individual character codes, obtained by the plaintext encoder, to encrypt the first numerical value into an encrypted value with an identical number of bits, by using an initial value set in a register, and then to encrypt the rest of the input numerical values by alternately repeating updating of the register value by using at least part of the encrypted value and encryption of the numerical value by using the updated register value. A character code generator converts the individual encrypted values obtained by the encryptor to corresponding character codes, thereby generating ciphertext.

### CROSS-REFERENCE TO RELATED APPLICATIONS

This application is based upon and claims the benefits of priority from the prior Japanese Patent Application No. 2005-250818, filed on Aug. 31, 2005, the entire contents of which are incorporated herein by reference.

### BACKGROUND OF THE INVENTION

1. Field of the Invention

The present invention relates to a computer-readable recording medium recording a character code encryption program for encrypting character codes, and a character code encryption method for performing such encryption. More particularly, the present invention relates to a computer-readable recording medium recording a character code encryption program for encrypting character codes into different character codes, and a character code encryption method for performing such encryption.

2. Description of the Related Art

Part of data handled by computers is encrypted in order to prevent leak of information or the like. To this end, various encryption algorithms have been devised such as AES (Advanced Encryption Standard) and DES (Data Encryption Standard) (see Unexamined Japanese Patent Publication No. H08-227269, for example).

Data handled by computers includes those described by a sequence of character codes. Character codes are numbers uniquely assigned on a one-by-one basis to letters and symbols such as the alphabet, numbers, and kanji or Chinese characters. Alphanumeric characters can be represented by one-byte character codes, whereas kanji characters, which are much greater in number, are represented by two-byte character codes.

When encrypting data described by a sequence of such character codes, it is desirable that the encrypted data should also be able to be represented by character codes, for the reason stated below.

In Shift_JIS or EUC (Extended UNIX (registered trademark) Code), for example, one character is represented by a two-byte character code, but not all bits of the two-byte (16-bit) code are used as the character code. Specifically, 12 or 13 bits in two bytes are sufficient to represent characters ordinarily used in the Japanese language. Accordingly, in some programs handling character codes, only those bits of the two-byte codes which represent character codes are read out. In such cases, if the two-byte character codes are in their entirety encrypted according to AES or DES, partially read data cannot be correctly decrypted.

Namely, in the case of encrypting character codes used in an existing system, the encrypted data should also be recognizable as a sequence of character codes in order to ensure normal operation of the system.

In view of this, encryption techniques have been devised whereby the encrypted character codes also take the form of a sequence of character codes. As such encryption techniques, a technique using a character code conversion table (random number table) is known, for example.

According to the technique using a character code conversion table, the character code conversion table is prepared beforehand in which plaintext characters and ciphertext characters are mapped in association with each other (character-to-character correspondences are defined). When plaintext to be encrypted is input, the individual characters in the plaintext are converted to respective different characters mapped in the character code conversion table. This encryption technique can therefore convert a sequence of character codes to a sequence of different character codes.

Where the character code conversion table is used, however, character codes before the conversion and those after the conversion are in one-to-one relations. Accordingly, if the same character is repeated, an identical character appears consecutively also after the conversion. This enhances the risk of encrypted data being decrypted by an unauthorized person, and thus, the technique cannot be used for highly confidential data.

To eliminate the inconvenience, a technique of converting encrypted data, encrypted according to an ordinary encryption algorithm, to character codes has been proposed. With this technique, binary data encrypted according to AES or DES is converted to character codes by using BASE64 or the like. In BCD, each digit of a decimal number is represented by a four-bit binary number, and BASE64 is a technique used to convert the contents of binary data attached to electronic mail to character codes.

Where encrypted data is converted to character codes, however, the sequence of converted characters becomes longer than the original sequence of characters.

Let it be assumed that two two-byte characters (four bytes in total) with character codes “0x20” and “0x21,” for example, are encrypted according to AES, thus obtaining four-byte binary data “0×F901.” This binary data, when represented by a binary number, is “1111100100000001.” When converting binary data to character codes according to BASE64, the binary data is segmented into units of six bits and each six-bit data segment is treated as a two-byte character code.

Specifically, in order for the number of bits to become a multiple of “6,” two bits of “0” are added to the end of the bit sequence; therefore, “111110010000000100.” The first six bits of the data, that is, “111110,” are treated as a character code “0x3E,” the next six bits “010000” as a character code “0x10,” and the last six bits “000100” as a character code “0x04.” As a result, six bytes of character codes are generated.

If the sequence of character codes lengthens as a result of the encryption in this manner, it is possible that an application program will fail to normally process the character codes. For example, databases often use fields with predetermined data lengths for storing character strings. If a character string to be stored in a certain field of fixed length is lengthened as a result of the encryption, the encrypted data may possibly fail to be stored in the field, and as a consequence, normal operation of the system cannot be secured.

### SUMMARY OF THE INVENTION

The present invention was created in view of the above circumstances, and an object thereof is to provide a computer-readable recording medium recording a character code encryption program capable of encrypting character codes without changing data lengths thereof, and a character code encryption method.

To achieve the object, there is provided a computer-readable recording medium recording a character code encryption program for encrypting character codes. The character code encryption program recorded on the recording medium causes a computer to function as a conversion table memory for storing at least one conversion table in which are registered correspondences permitting reciprocal conversion between character codes of a predetermined character coding scheme and respective numerical values of predetermined bit length, a plaintext encoder, responsive to input of plaintext constituted by at least one character code, for looking up the conversion table associated with the character coding scheme of character codes constituting the plaintext, to convert the character codes included in the plaintext to corresponding numerical values, an encryptor for successively acquiring the numerical values of the individual character codes, obtained by the plaintext encoder, to encrypt a first numerical value into an encrypted value with an identical number of bits, by using an initial value set in a register, and then to encrypt second and subsequent numerical values by alternately repeating updating of the register value by using at least part of the encrypted value and encryption of the numerical value by using the updated register value, and a character code generator for looking up the conversion table associated with a predetermined character coding scheme, to convert the individual encrypted values obtained by the encryptor to corresponding character codes.

Also, to achieve the above object, there is provided a character code encryption method for encrypting character codes through processing of a computer. The character code encryption method comprises the step of previously storing, in a conversion table memory, at least one conversion table in which are registered correspondences permitting reciprocal conversion between character codes of a predetermined character coding scheme and respective numerical values of predetermined bit length, and looking up, in response to input of plaintext constituted by at least one character code, the conversion table associated with the character coding scheme of character codes constituting the plaintext, to convert the character codes included in the plaintext to corresponding numerical values, the step of successively acquiring the numerical values of the individual character codes, obtained by the encoding, to encrypt a first numerical value into an encrypted value with an identical number of bits, by using an initial value set in a register, and then to encrypt second and subsequent numerical values by alternately repeating updating of the register value by using at least part of the encrypted value and encryption of the numerical value by using the updated register value, and the step of looking up the conversion table associated with a predetermined character coding scheme, to convert the individual encrypted values obtained by the encryption to corresponding character codes.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 illustrates an outline of the present invention.

FIG. 2 shows an exemplary system configuration of a first embodiment.

FIG. 3 shows an exemplary hardware configuration of a server used in the first embodiment.

FIG. 4 is a block diagram illustrating the function of the server.

FIG. 5 shows an exemplary data structure of a conversion table.

FIG. 6 is a block diagram illustrating the function of an encryptor.

FIG. 7 illustrates the process of a character code encoder in the encryptor.

FIG. 8 illustrates transitions of data during an encryption process.

FIG. 9 illustrates the process of a character code generator in the encryptor.

FIG. 10 is a block diagram illustrating the function of a decryptor.

FIG. 11 illustrates the process of a character code encoder in the decryptor.

FIG. 12 illustrates transitions of data during a decryption process.

FIG. 13 illustrates the process of a character code generator in the decryptor.

FIG. 14 shows the configuration of an encryptor for performing parallel processing.

FIG. 15 shows the configuration of a decryptor for performing parallel processing.

### DESCRIPTION OF THE PREFERRED EMBODIMENTS

Preferred embodiments of the present invention will be described below with reference to the accompanying drawings.

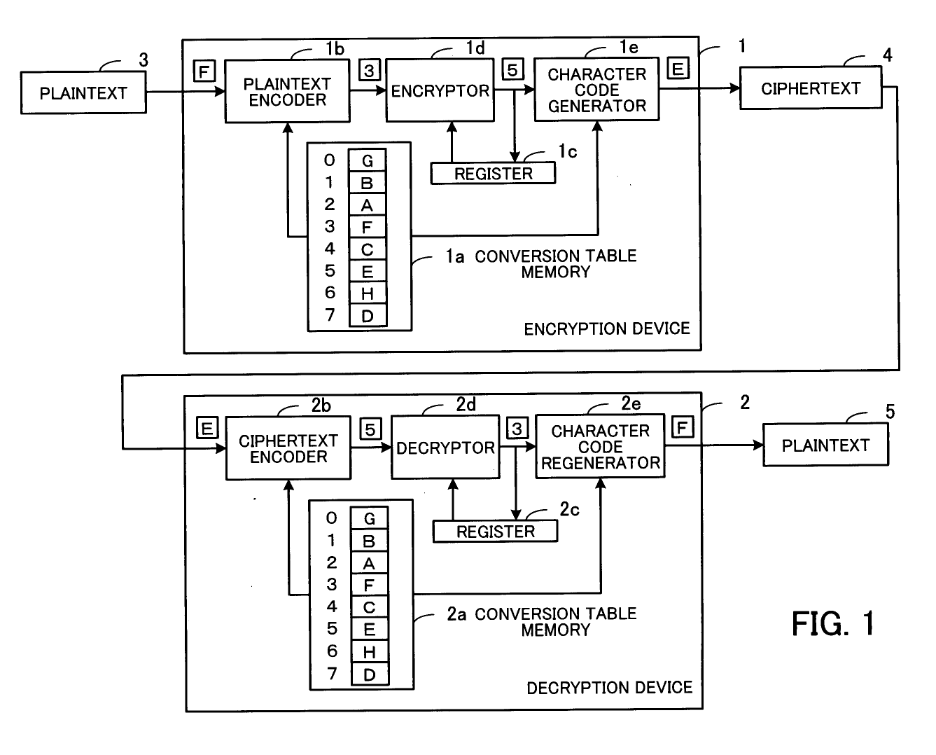

FIG. 1 illustrates an outline of the present invention. As shown in FIG. 1, an encryption device 1 encrypts plaintext 3 and generates ciphertext 4. A decryption device 2 decrypts the ciphertext 4 and generates plaintext 5.

The encryption device 1 includes a conversion table memory 1a, a plaintext encoder 1b, a register 1c, an encryptor id, and a character code generator 1e.

The conversion table memory 1a stores at least one conversion table in which are registered correspondences permitting reciprocal conversion between character codes of a predetermined character coding scheme and respective numerical values of predetermined bit length. The number of character codes that can be registered in the conversion table is 2ⁿ (n is the bit length of each numerical value). For example, if the number of character codes to be registered is not greater than 2¹², each character code is encoded into a 12-bit numerical value.

When input with the plaintext 3 constituted by at least one character code, the plaintext encoder 1b looks up the conversion table associated with the character coding scheme of the character codes constituting the plaintext 3, and converts the character codes included in the plaintext 3 to corresponding numerical values. For example, in FIG. 1, the character code “F” is converted to the numerical value “3.”

The encryptor 1d successively acquires the numerical values of the individual character codes, obtained by the plaintext encoder 1b, and encrypts the first numerical value into an encrypted value with an identical number of bits by using an initial value set in the register 1c. Subsequently, the encryptor 1d encrypts the second and following numerical values by alternately repeating updating of the value of the register 1c by using at least part of the encrypted value and encryption of the numerical value by using the updated value of the register 1c.

For example, if the first numerical value is “3” and is encrypted into “5,” the value of the register 1c is updated by using the value “5,” and then the subsequent numerical value is encrypted by using the updated value of the register 1c.

The character code generator 1e looks up the conversion table associated with a predetermined character coding scheme and converts the individual encrypted values, obtained by the encryptor 1d, to corresponding character codes. If the character coding scheme of the plaintext 3 is identical with that of the ciphertext 4, an identical conversion table is looked up. In the example of FIG. 1, the same conversion table is looked up and the encrypted value “5” is converted to the character code “E.” The ciphertext 4 is constituted by the character codes generated by the conversion process.

The decryption device 2 includes a conversion table memory 2a, a ciphertext encoder 2b, a register 2c, a decryptor 2d, and a character code regenerator 2e.

The conversion table memory 2a stores at least one conversion table in which are registered correspondences permitting reciprocal conversion between character codes of a predetermined character coding scheme and respective numerical values of predetermined bit length.

When input with ciphertext constituted by at least one character code, the ciphertext encoder 2b looks up the conversion table associated with the character coding scheme of the character codes constituting the ciphertext 4, and converts the character codes included in the ciphertext to corresponding encrypted values.

The decryptor 2d successively acquires the encrypted values of the individual character codes, obtained by the ciphertext encoder 2b, and decrypts the first encrypted value into a value with an identical number of bits by using an initial value set in the register 2c. The initial value of the register 2c is equal to the initial value set in the register 1c at the time of encryption.

Subsequently, the decryptor 2d decrypts the second and following encrypted values by alternately repeating updating of the register value by using at least part of the encrypted value which has been decrypted and decryption of the encrypted value by using the updated register value.

The character code regenerator 2e looks up the conversion table associated with the predetermined character coding scheme and converts the individual numerical values, obtained by the decryptor 2d, to corresponding character codes. The sequence of character codes generated by the conversion is output as the plaintext 5.

When the system configured as described above is input with plaintext 3, the plaintext encoder 1b converts the character codes included in the plaintext 3 to respective numerical values. Subsequently, the encryptor 1d successively acquires the numerical values of the individual character codes, obtained by the plaintext encoder 1b, and encrypts the first numerical value into an encrypted value with an identical number of bits by using the initial value set in the register 1c. Then, the rest of the input numerical values are encrypted by alternately repeating the updating of the register value by using at least part of the encrypted value and the encryption of the numerical value by using the updated register value. The individual encrypted values obtained by the encryptor 1d are converted to respective character codes by the character code generator 1e, whereby ciphertext 4 is generated.

When the decryption device 2 is input with the ciphertext 4, the ciphertext encoder 2b converts the character codes included in the ciphertext 4 to encrypted values. Subsequently, the decryptor 2d successively acquires the encrypted values of the individual character codes, obtained by the ciphertext encoder 2b, and decrypts the first encrypted value by using the initial value set in the register 2c. The decryptor 2d then decrypts the second and subsequent encrypted values by alternately repeating the updating of the register value by using at least part of the encrypted value which has been decrypted and the decryption of the encrypted value by using the updated register value. The individual numerical values obtained by the decryptor 2d are converted to respective character codes by the character code regenerator 2e and output as plaintext 5.

The plaintext 5 generated in this manner is identical in content with the plaintext 3 previously encrypted. Namely, the encrypted plaintext is correctly decrypted. Moreover, the plaintext is encrypted on a character-by-character basis and each encrypted character is represented by one character code; therefore, the number of characters does not increase as a result of the encryption.

Further, the register is used for the encryption and the register value is updated each time a character is encrypted. Thus, even if an identical character is repeated, a sequence of varying characters is output as a result of the encryption. Consequently, higher security is ensured than in the case where the character codes of individual characters are converted to different character codes by merely using a character code conversion table.

The character code encryption/decryption technique can be applied, for example, to encryption of records to be registered in a database. Specifically, in order to prevent illegal access to storage devices where databases are configured or leak of information as a result of theft of such storage devices, it is desirable that each data should be encrypted before registration. In ordinary databases holding records, however, there is a limit to the number of characters up to which individual fields can register character strings. It is therefore necessary that the number of characters should not increase as a result of the encryption.

Referring now to an exemplary case of encrypting character strings to be registered in a database, specific embodiments of the present invention will be described.

### First Embodiment

A first embodiment will be described in detail.

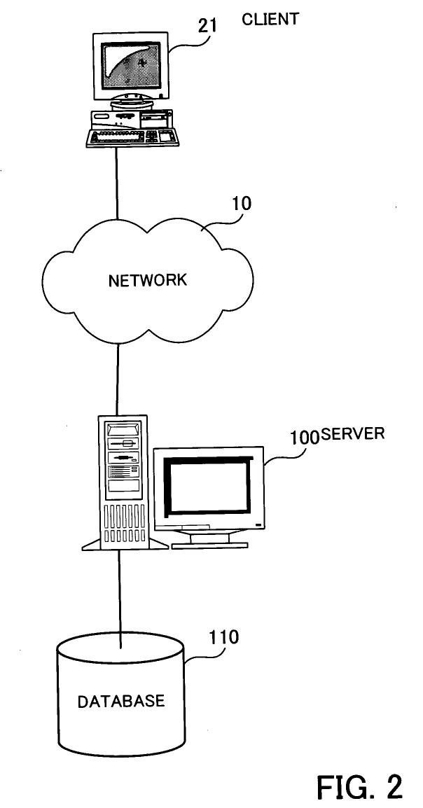

FIG. 2 exemplifies a system configuration of the first embodiment, wherein character strings to be stored in a database 110 are encrypted.

A client 21 is connected via a network 10 to a server 100, to which the database 110 is connected.

The client 21 is a computer used by a user, and the server 100 is a computer having the function of managing the database 110. Various data such as character codes is stored in the database 110 after being encrypted.

In the illustrated example, the server 100 encrypts/decrypts character codes when inputting/retrieving the character codes to/from the database 110. Data communicated between the server 100 and the client 21 may also be encrypted using an encryption technique such as DES.

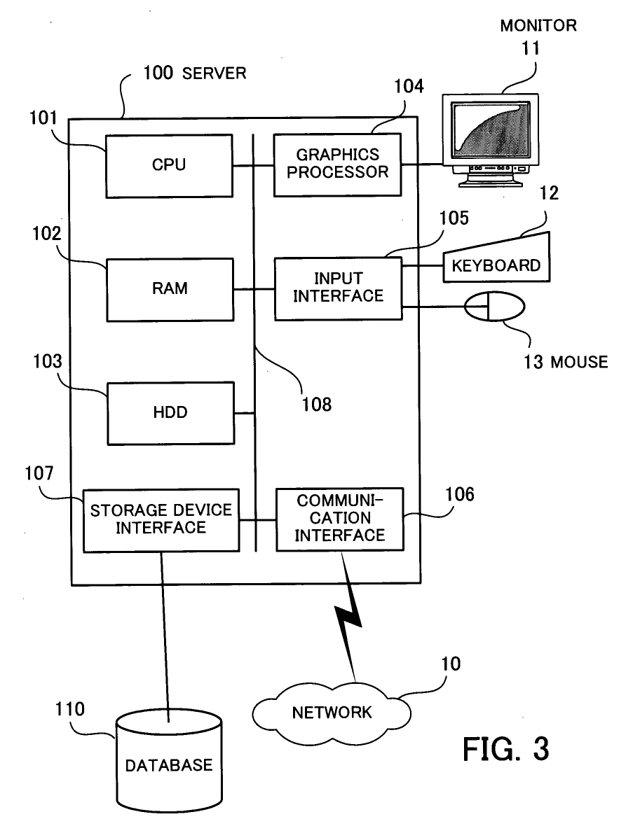

FIG. 3 shows an exemplary hardware configuration of the server used in the first embodiment. The server 100 is in its entirety under the control of a CPU (Central Processing Unit) 101. To the CPU 101 are connected, via a bus 108, a RAM (Random Access Memory) 102, an HDD (Hard Disk Drive) 103, a graphics processor 104, an input interface 105, a communication interface 106, and a storage device interface 107.

The RAM 102 temporarily stores at least part of OS (Operating System) and application programs executed by the CPU 101. Also, the RAM 102 stores various other data necessary for the processing by the CPU 101. The HDD 103 stores the OS and application programs.

The graphics processor 104 is connected with a monitor 11. In accordance with instructions from the CPU 101, the graphics processor 104 displays images on the screen of the monitor 11. The input interface 105 is connected with a keyboard 12 and a mouse 13, and sends signals from the keyboard 12 and the mouse 13 to the CPU 101 via the bus 108.

The communication interface 106 is connected to the network 10 and permits data to be exchanged with other computers via the network 10.

The storage device interface 107 is a communication interface which permits input/output of data to/from the database 110.

The processing function of the first embodiment can be implemented by the hardware configuration described above. Although FIG. 3 shows the hardware configuration of the server 100, the client 21 also may have a similar hardware configuration.

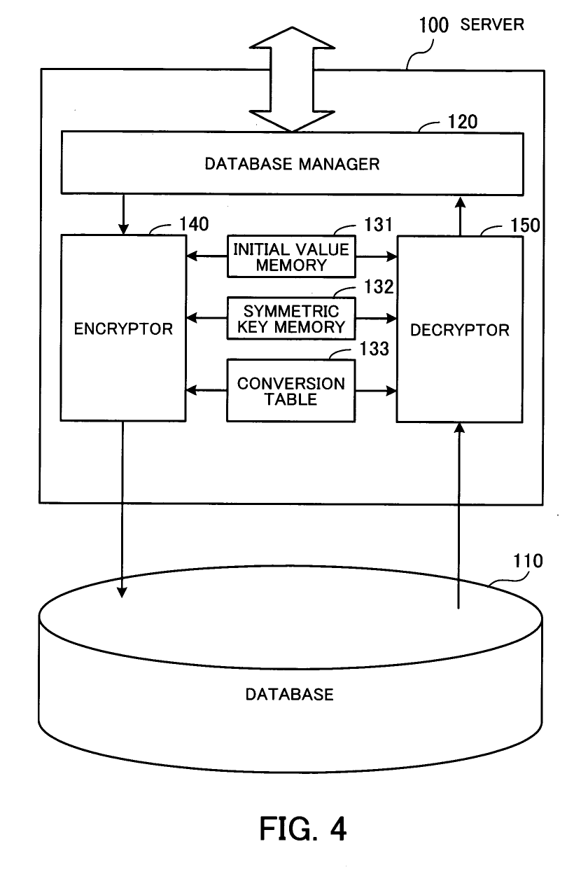

FIG. 4 is a block diagram illustrating the function of the server. The server 100 includes a database manager 120, an initial value memory 131, a symmetric key memory 132, a conversion table 133, an encryptor 140, and a decryptor 150.

In response to a request from the client 21, the database manager 120 inputs/retrieves data to/from the database 110. When inputting character code data to the database 110, the database manager 120 writes, via the encryptor 140, the character codes into the database 110. On the other hand, when retrieving character codes from the database 110, the database manager 120 acquires, via the decryptor 150, the character codes stored in the database 110.

The initial value memory 131 is a storage area storing the initial value (initial vector) of shift registers used in the encryption and decryption processes by the encryptor 140 and the decryptor 150, respectively. The symmetric key memory 132 is a storage area storing symmetric key data used in the encryption and decryption processes by the encryptor 140 and the decryptor 150, respectively.

The conversion table 133 is a data conversion table for encoding each character code into data of a predetermined bit length and vice versa. In the conversion table 133 are set the correspondences between character codes and respective numerical values.

The encryptor 140 encrypts the character codes received from the database manager 120 and stores the encrypted data in the database 110. During the encryption, the initial value memory 131, the symmetric key memory 132 and the conversion table 133 are looked up.

In response to a request from the database manager 120, the decryptor 150 acquires encrypted character codes from the database 110 and decrypts the acquired character codes. Then, the decryptor 150 transfers the decrypted character codes to the database manager 120. During the decryption, the initial value memory 131, the symmetric key memory 132 and the conversion table 133 are looked up.

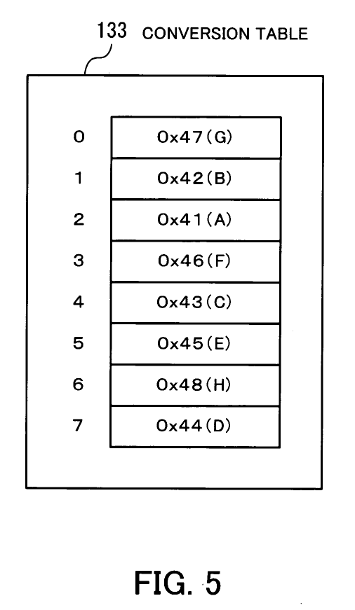

FIG. 5 shows an exemplary data structure of the conversion table. The conversion table 133 indicates the correspondences between character codes and respective numerical values. Specifically, with respect to each field for storing a character code, a numerical value corresponding to the character code is shown by an index.

In the example of FIG. 5, it is assumed that only the characters in the range of “A” to “H” are to be processed, for ease of explanation. In this case, eight (2³) different numerical values have only to be defined, and therefore, each numerical value can be represented by three bits.

The character codes may be stored in the conversion table 133 either in alphabetical order or at random. In the example of FIG. 5, the character code of “G,” that is, “0x47,” is stored for the numerical value “0,” the character code of “B,” that is, “0x42,” is stored for the numerical value “1,” the character code of “A,” that is, “0x41,” is stored for the numerical value “2,” the character code of “F,” that is, “0x46,” is stored for the numerical value “3,” the character code of “C,” that is, “0x43,” is stored for the numerical value “4,” the character code of “E,” that is, “0x45,” is stored for the numerical value “5,” the character code of “H,” that is, “0x48,” is stored for the numerical value “6,” and the character code of “D,” that is, “0x44,” is stored for the numerical value “7.” The character codes appearing in FIG. 5 conform to the table of ASCII character codes.

The processing function of the encryptor 140 will be now described in more detail. In the first embodiment, the CFB (Cipher Feed Back) mode of AES is used as an encryption algorithm.

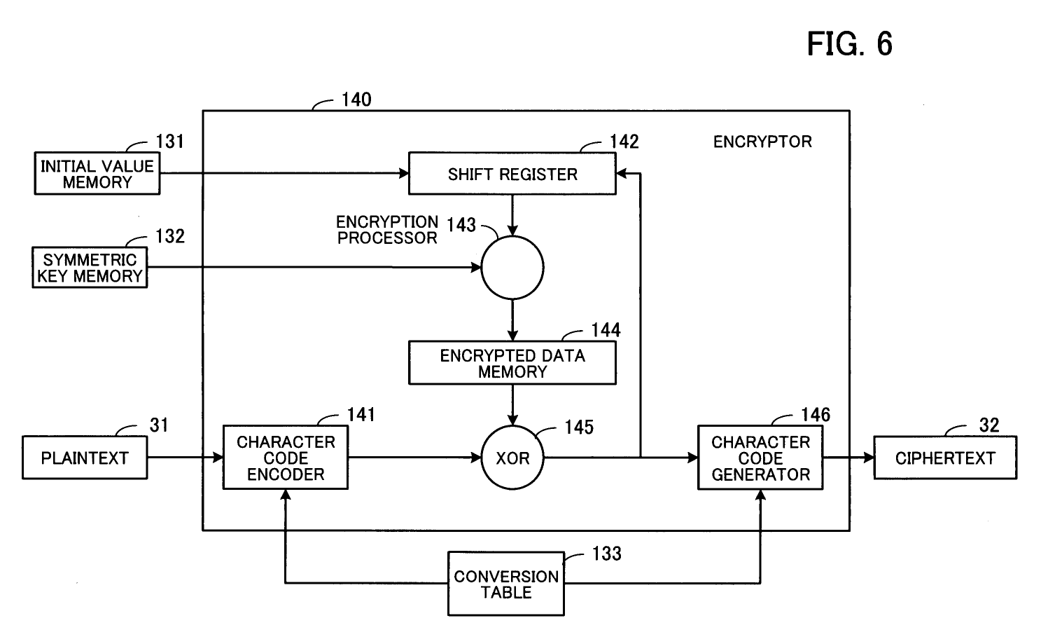

FIG. 6 is a block diagram illustrating the function of the encryptor. The encryptor 140 includes a character code encoder 141, a shift register 142, an encryption processor 143, an encrypted data memory 144, an exclusive-OR (XOR) operator 145, and a character code generator 146.

When input with plaintext 31 from the database manager 120, the character code encoder 141 looks up the conversion table 133 and encodes each of the character codes constituting the plaintext 31 into a three-bit numerical value. Then, the character code encoder 141 supplies the numerical value generated from each character code to the exclusive-OR operator 145.

The shift register 142 is a register capable of shifting data therein by a predetermined number of bits each time the exclusive-OR operator 145 outputs an operation result. In this example, the data in the shift register 142 shifts to the left by three bits and the operation result from the exclusive-OR operator 145 is stored in the right-hand three bits of the shift register. When the encryption process is started, the initial value stored in the initial value memory 131 is set in the shift register 142.

The encryption processor 143 encrypts the value set in the shift register 142, by using the key data stored in the symmetric key memory 132. Then, the encryption processor 143 stores the encrypted data in the encrypted data memory 144.

The exclusive-OR operator 145 derives an exclusive OR of the three-bit numerical value output from the character code encoder 141 and the three-bit data at the head (left) of the encrypted data memory 144. Then, the exclusive-OR operator 145 transfers the operation result to the shift register 142 and the character code generator 146.

The character code generator 146 looks up the conversion table 133 and converts the operation result of the exclusive-OR operator 145 to a character code. Then, the character code generator 146 stores the converted character code in the database 110 as ciphertext 32.

When the encryptor 140 configured as described above is input with plaintext 31, first, the character code encoder 141 encodes the plaintext 31 into a sequence of numerical values.

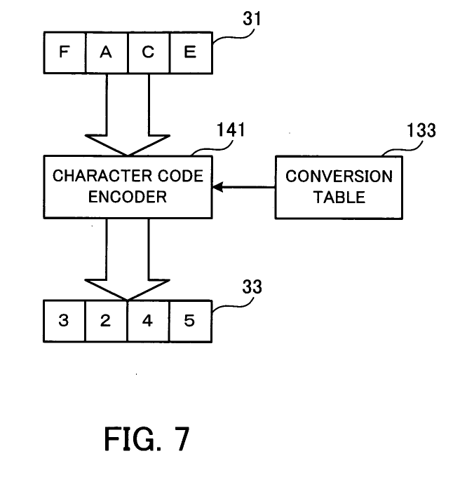

FIG. 7 illustrates the process of the character code encoder in the encryptor, wherein the character string “FACE” is input as the plaintext 31, by way of example. The character code encoder 141 looks up the conversion table 133 and encodes the characters of the plaintext 31 in order from the beginning. In the illustrated example, the character “F” is converted to “3,” the character “A” to “2,” the character “C” to “4,” and the character “E” to “5.”

The encoded data 33 thus obtained by the conversion is successively input to the exclusive-OR operator 145, whereupon the exclusive-OR operator 145 and the encryption processor 143 operate in cooperation with each other to encrypt the encoded data 33.

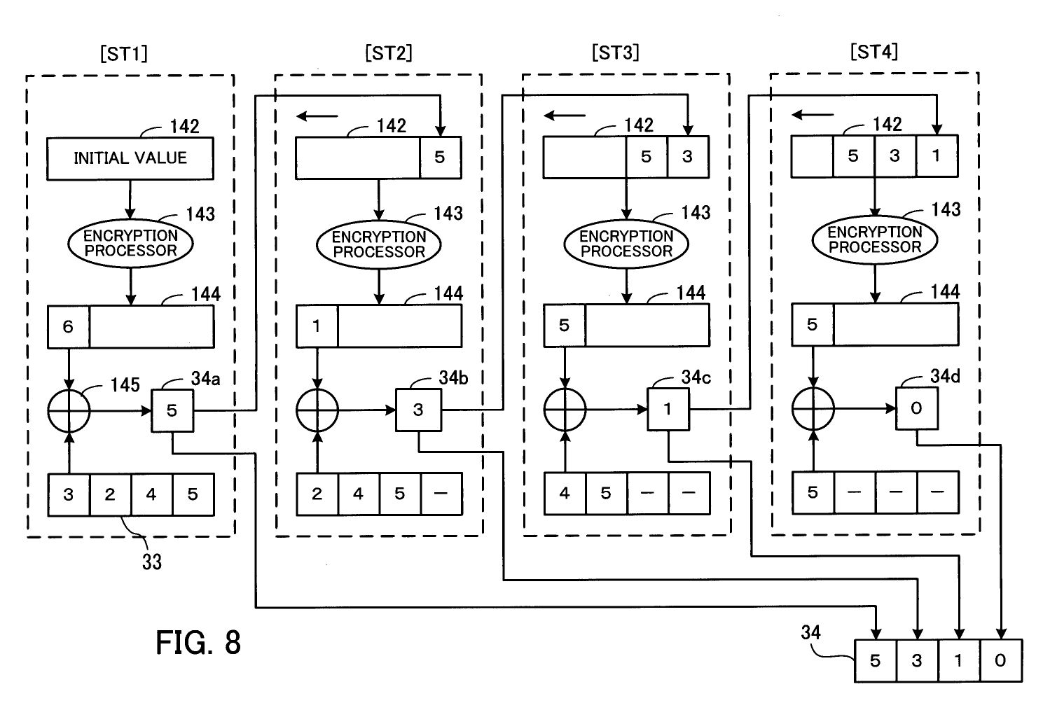

FIG. 8 illustrates transitions of data during the encryption process. The illustrated example shows the manner of encrypting each of the three-bit numerical values “3,” “2,” “4” and “5” which constitute the encoded data 33 and which are input in the order mentioned.

The first state ST1 shows how the first numerical value of the encoded data 33 is encrypted. At this time, the shift register 142 has the initial value set therein. Upon start of the encryption process, first, the encryption processor 143 encrypts the value in the shift register 142 and stores the encrypted data in the encrypted data memory 144. It is assumed here that the three-bit value at the head of the encrypted data is “6.”

Subsequently, the exclusive-OR operator 145 obtains an exclusive OR of the three bits at the head of the data stored in the encrypted data memory 144 and the three bits at the head of the encoded data 33. In the example of FIG. 8, an exclusive OR of “6” and “3” is derived, and “5” is obtained as an operation result 34a.

The second state ST2 shows how the second numerical value of the encoded data 33 is encrypted. At this point of time, the shift register 142 is in a state such that the data therein is shifted to the left by three bits, with the previous operation result 34a stored in the right-hand three bits thereof. While in this state, the encryption processor 143 encrypts the value in the shift register 142 and stores the encrypted data in the encrypted data memory 144. It is assumed here that the three-bit value at the head of the encrypted data is “1.”

Subsequently, the exclusive-OR operator 145 obtains an exclusive OR of the three bits at the head of the data stored in the encrypted data memory 144 and the three bits at the head of the encoded data 33. In the example of FIG. 8, an exclusive OR of “1” and “2” is derived, and “3” is obtained as the operation result 34b.

The numerical values constituting the encoded data 33 are thereafter encrypted in like manner.

The third state ST3 shows how the third numerical value of the encoded data 33 is encrypted. In the illustrated example, an exclusive OR of “5” and “4” is derived, and “1” is obtained as the operation result 34c.

The fourth state ST4 shows how the fourth numerical value of the encoded data 33 is encrypted. In the illustrated example, an exclusive OR of “5” and “5” is derived, and “0” is obtained as the operation result 34d.

The sequence of the operation results 34a to 34d obtained by the above process constitutes encrypted data 34. The encrypted data 34 is input to the character code generator 146, which then converts the encrypted data to ciphertext 32.

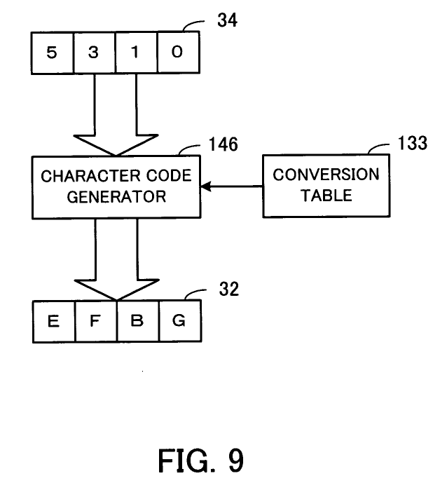

FIG. 9 illustrates the process of the character code generator in the encryptor. In FIG. 9, the encrypted data 34 constituted by “5,” “3,” “1” and “0” is input to the character code generator 146. The character code generator 146 looks up the conversion table 133 and converts the encrypted data 34 to character codes in order from the first numerical value. In the illustrated example, the numerical value “5” is converted to “E,” the numerical value “3” to “F,” the numerical value “1” to “B,” and the numerical value “0” to “G.” The ciphertext 32 obtained in this manner is stored in the database 110.

The decryption process for decrypting the ciphertext 32 stored in the database 110 will be now escribed in detail.

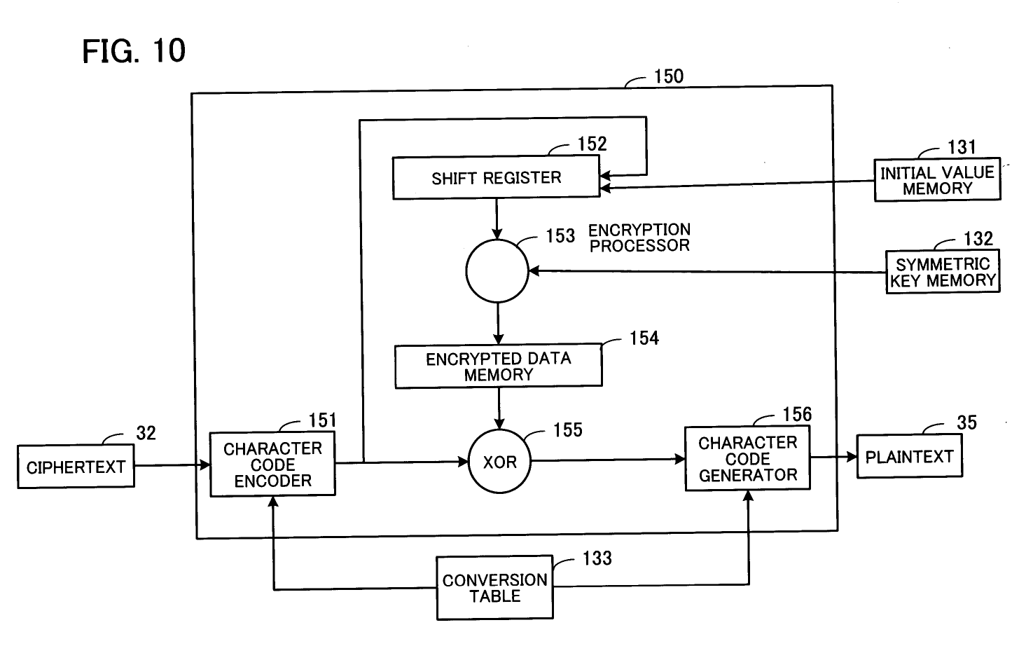

FIG. 10 is a block diagram illustrating the function of the decryptor. The decryptor 150 includes a character code encoder 151, a shift register 152, an encryption processor 153, an encrypted data memory 154, an exclusive-OR operator 155, and a character code generator 156.

On acquiring the ciphertext 32 from the database 110, the character code encoder 151 looks up the conversion table 133 and encodes each of the character codes constituting the ciphertext 32 into a three-bit numerical value. Then, the character code encoder 151 supplies the numerical value generated from each character code to the shift register 152 and the exclusive-OR operator 155.

The shift register 152 is a register capable of shifting data therein by a predetermined number of bits each time the exclusive-OR operator 155 outputs an operation result. In this example, the data in the shift register 152 shifts to the left by three bits and the numerical value output from the character code encoder 151 is stored in the right-hand three bits of the shift register. When the decryption process is started, the initial value stored in the initial value memory 131 is set in the shift register 152.

The encryption processor 153 encrypts the value set in the shift register 152, by using the key data stored in the symmetric key memory 132. Then, the encryption processor 153 stores the encrypted data in the encrypted data memory 154.

The exclusive-OR operator 155 derives an exclusive OR of the three-bit numerical value output from the character code encoder 151 and the three-bit data at the head (left) of the encrypted data memory 154. Then, the exclusive-OR operator 155 transfers the operation result to the character code generator 156.

The character code generator 156 looks up the conversion table 133 and converts the operation result of the exclusive-OR operator 155 to a character code. Then, the character code generator 156 transfers plaintext 35 constituted by the converted character codes to the database manager 120.

When the decryptor 150 configured as described above is input with the ciphertext 32, first, the character code encoder 151 encodes the ciphertext 32 into a sequence of numerical values.

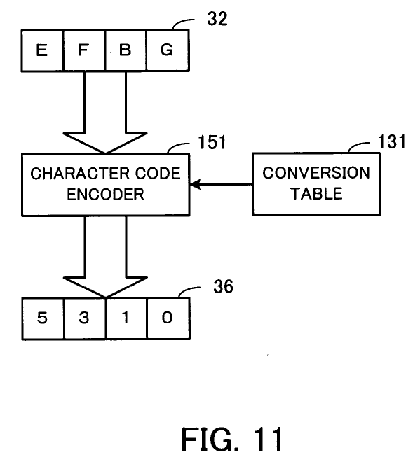

FIG. 11 illustrates the process of the character code encoder in the decryptor, wherein the character string “EFBG” is input as the ciphertext 32, by way of example. The character code encoder 151 looks up the conversion table 133 and encodes the characters of the ciphertext 32 in order from the beginning. In the illustrated example, the character “E” is converted to “5,” the character “F” to “3,” the character “B” to “1,” and the character “G” to “0.”

The encoded data 36 thus obtained by the conversion is identical in content with the encrypted data 34 from which the ciphertext 32 was generated. The encoded data 36 is successively input to the exclusive-OR operator 155, whereupon the exclusive-OR operator 155 and the encryption processor 153 operate in cooperation with each other to decrypt the encoded data 36.

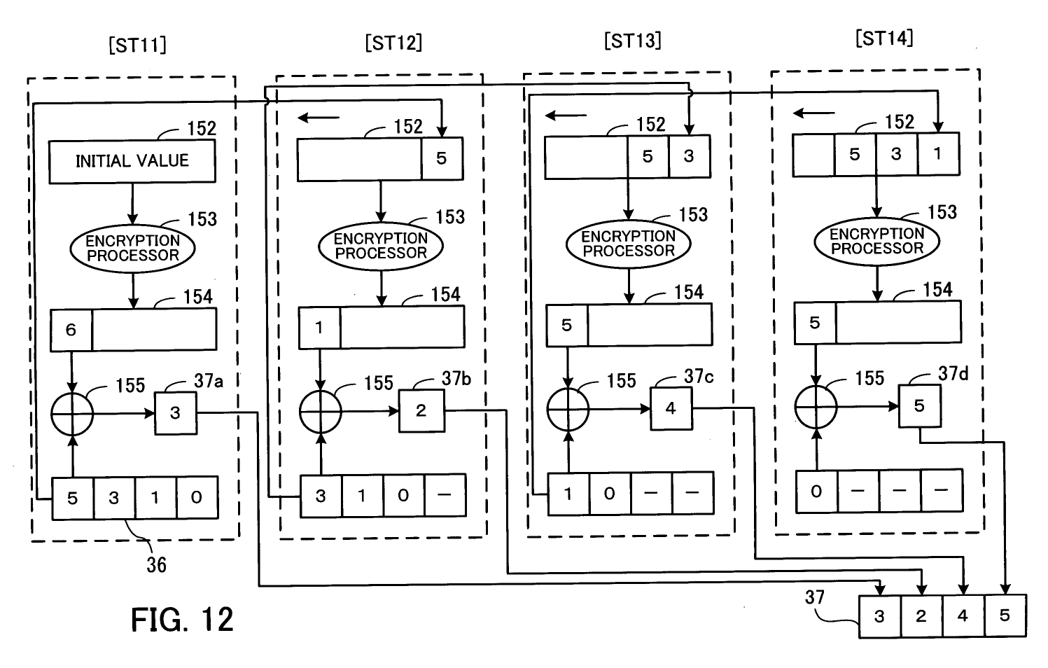

FIG. 12 illustrates transitions of data during the decryption process. The illustrated example shows the manner of decrypting each of the three-bit numerical values “5,” “3,” “1” and “0” which constitute the encoded data 36 and which are input in the order mentioned.

The first state ST11 shows how the first numerical value of the encoded data 36 is decrypted. At this time, the shift register 152 has the initial value set therein. Upon start of the decryption process, first, the encryption processor 153 encrypts the value in the shift register 152 and stores the encrypted data in the encrypted data memory 154. The data stored at this time in the encrypted data memory 154 is identical with the data stored in the encrypted data memory 144 in the first state during the encryption process (see ST1 in FIG. 8). Thus, the three-bit value at the head of the encrypted data is “6.”

Subsequently, the exclusive-OR operator 155 obtains an exclusive OR of the three bits at the head of the data stored in the encrypted data memory 154 and the three bits at the head of the encoded data 36. In the example of FIG. 12, an exclusive OR of “6” and “5” is derived, and “3” is obtained as the operation result 37a. The operation result 37a is identical with the numerical value on which the operation of the exclusive-OR operator 145 was performed in the first state during the encryption process and which constituted the encoded data 33 (see ST1 in FIG. 8). Namely, the original value is restored by the decryption.

The second state ST12 shows how the second numerical value of the encoded data 36 is decrypted. At this point of time, the shift register 152 is in a state such that the data therein is shifted to the left by three bits and also that the numerical value on which the previous exclusive-OR operation was performed is stored in the right-hand three bits of the shift register. While in this state, the encryption processor 153 encrypts the value in the shift register 152 and stores the encrypted data in the encrypted data memory 154. The three-bit value at the head of the encrypted data is “1.”

Subsequently, the exclusive-OR operator 155 obtains an exclusive OR of the three bits at the head of the data stored in the encrypted data memory 154 and the three bits at the head of the encoded data 36. In the example of FIG. 12, an exclusive OR of “1” and “3” is derived, and “2” is obtained as the operation result 37b.

The numerical values constituting the encoded data 36 are thereafter decrypted in like manner.

The third state ST13 shows how the third numerical value of the encoded data 36 is decrypted. In the illustrated example, an exclusive OR of “5” and “1” is derived, and “4” is obtained as the operation result 37c.

The fourth state ST14 shows how the fourth numerical value of the encoded data 36 is decrypted. In the illustrated example, an exclusive OR of “5” and “0” is derived, and “5” is obtained as the operation result 37d.

The sequence of the operation results 37a to 37d obtained by the above process constitutes decrypted data 37, which is identical in content with the encoded data 33 (see FIG. 7) derived during the encryption process. The decrypted data 37 is input to the character code generator 156, which then converts the decrypted data to plaintext 35.

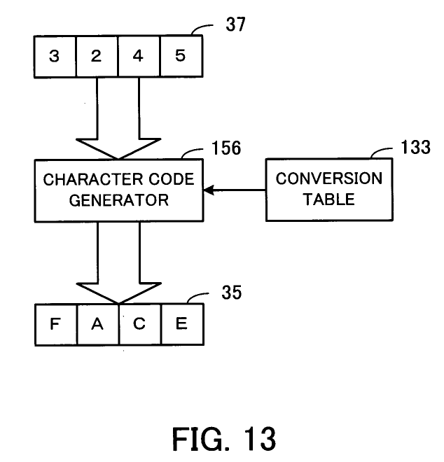

FIG. 13 illustrates the process of the character code generator in the decryptor. In FIG. 13, the decrypted data 37 constituted by “3,” “2,” “4” and “5” is input to the character code generator 156. The character code generator 156 looks up the conversion table 133 and converts the decrypted data 37 to character codes in order from the first numerical value. In the illustrated example, the numerical value “3” is converted to “F,” the numerical value “2” to “A,” the numerical value “4” to “C,” and the numerical value “5” to “E.” The plaintext 35 obtained in this manner is transferred to the database manager 120.

The plaintext 35 is constituted by the character string “FACE,” which is identical in content with the plaintext 31 input at the time of encryption. Thus, the ciphertext has been correctly decrypted. Moreover, in the database 110 are stored the character codes which are indicative of the character string “EFBG” and which have the same data length as that of the input plaintext 31. Namely, the encryption of plaintext into character codes and the decryption of the encrypted character codes are performed without changing the data length.

### Second Embodiment

A second embodiment will be now described. In the second embodiment, a plurality of character codes are encrypted by parallel processing. In the following description of the second embodiment, each character code is encoded into a 13-bit numerical value (character space for 2¹³ (=8192) different characters).

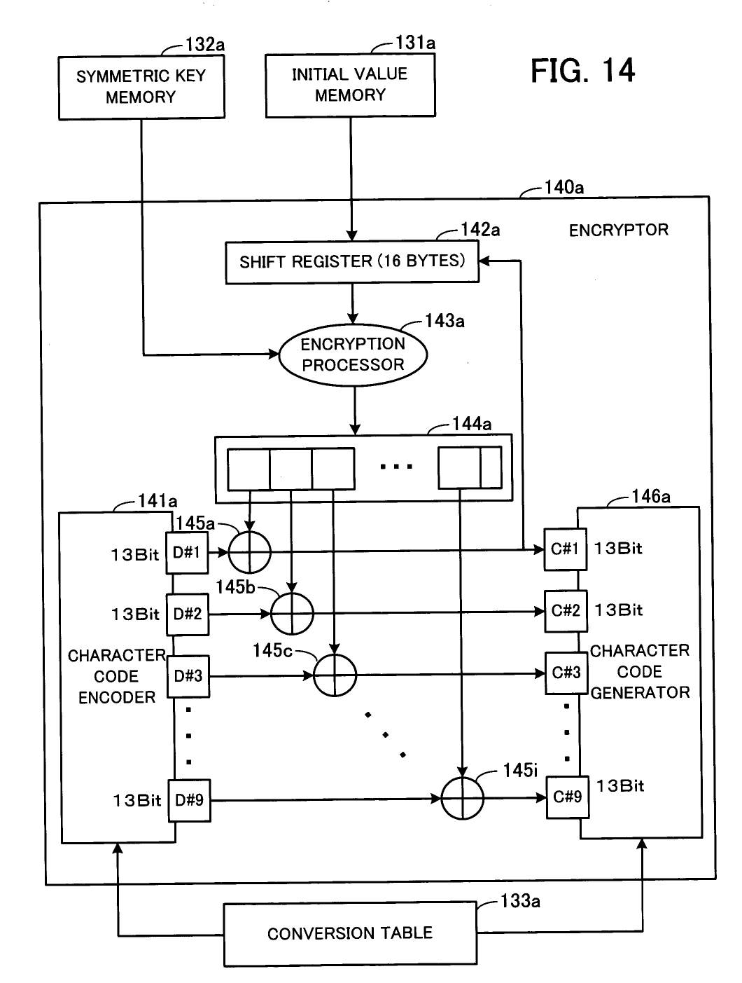

FIG. 14 shows the configuration of an encryptor for performing parallel processing. A conversion table 133a registers therein the correspondences between two-byte character codes and respective 13-bit numerical values.

The encryptor 140a includes a character code encoder 141a, a shift register 142a, an encryption processor 143a, an encrypted data memory 144a, nine exclusive-OR operators 145a, 145b, 145c, . . . , 145i, and a character code generator 146a.

When plaintext is input, the character code encoder 141a acquires characters codes corresponding to the first nine characters of the plaintext, and encodes the acquired character codes into corresponding 13-bit numerical values on the basis of the conversion table 133a. Subsequently, the character code encoder 141a encodes the succeeding nine character codes in like manner. The encoded numerical values corresponding to nine characters are input to the respective exclusive-OR operators 145a, 145b, 145c, . . . , 145i.

The shift register 142a is capable of storing data equivalent to 16 bytes. At the start of the encryption process, a 16-byte initial value previously stored in the initial value memory 131a is set in the shift register 142a. Subsequently, each time nine characters are encrypted, the value in the shift register 142a is shifted to the left by 13 bits, and at this time, the operation result of the exclusive-OR operator 145a is set in the right-hand 13 bits of the shift register.

The encryption processor 143a encrypts the value in the shift register 142a, by using the key data stored in the symmetric key memory 132a. In this example, the shift register 142a stores 16-byte data, and therefore, 16-byte encrypted data is generated. The encrypted data generated by the encryption processor 143a is stored in the encrypted data memory 144a.

The encrypted data memory 144a stores the 16-byte data encrypted by the encryption processor 143a. The data stored in the encrypted data memory 144a is segmented into units of 13 bits from the beginning, and the 13-bit data segments are input to the exclusive-OR operators 145a, 145b, 145c, . . . , 145i, respectively.

Each of the exclusive-OR operators 145a, 145b, 145c, . . . , 145i derives an exclusive OR of the corresponding 13-bit data input from the encrypted data memory 144a and the corresponding 13-bit data input from the character code encoder 141a. Then, the exclusive-OR operators 145a, 145b, 145c, . . . , 145i transfer their operation results to the character code generator 146a.

The character code generator 146a looks up the conversion table 133a and converts the operation results input from the respective exclusive-OR operators 145a, 145b, 145c, . . . , 145i to respective character codes.

With the encryptor 140a configured as described above, when plaintext is input, the input text is encrypted in such a manner that nine characters are processed in parallel. The number of parallel processes is “9” because the data stored in the encrypted data memory 144a is 16 bytes (128 bits) and thus a maximum of nine 13-bit data segments can be fetched from the stored data.

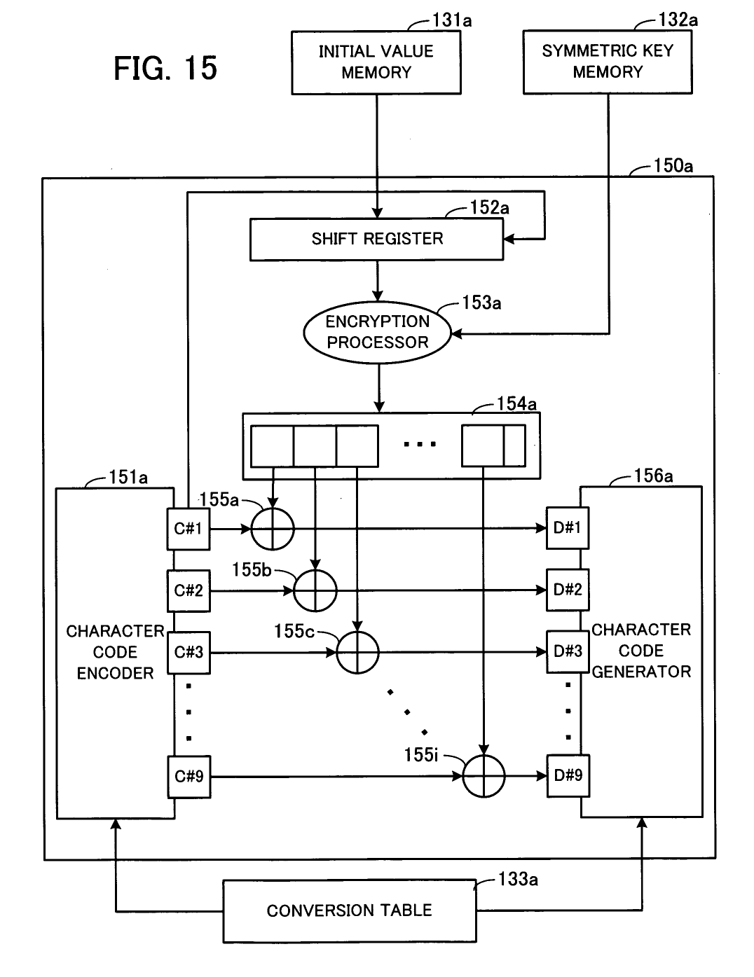

FIG. 15 shows the configuration of a decryptor for carrying out parallel processing.

The decryptor 150a includes a character code encoder 151a, a shift register 152a, an encryption processor 153a, an encrypted data memory 154a, nine exclusive-OR operators 155a, 155b, 155c, . . . , 155i, and a character code generator 156a.

When ciphertext is input, the character code encoder 151a acquires characters codes corresponding to the first nine characters of the ciphertext, and encodes the acquired character codes into corresponding 13-bit numerical values on the basis of the conversion table 133a. Subsequently, the character code encoder 151a encodes the succeeding nine character codes in like manner. The encoded numerical values corresponding to nine characters are input to the respective exclusive-OR operators 155a, 155b, 155c, . . . , 155i.

The shift register 152a can store 16-byte data. At the start of the decryption process, the 16-byte initial value previously stored in the initial value memory 131a is set in the shift register 152a. Subsequently, each time nine characters are decrypted, the value in the shift register 152a is shifted to the left by 13 bits, and at this time, the first 13-bit numerical value encoded by the character code encoder 151a is set in the right-hand 13 bits of the shift register.

The encryption processor 153a encrypts the value in the shift register 152a, by using the key data stored in the symmetric key memory 132a. In this example, the shift register 152a stores 16-byte data, and therefore, 16-byte encrypted data is generated. The encrypted data generated by the encryption processor 153a is stored in the encrypted data memory 154a.

The encrypted data memory 154a stores the 16-byte data encrypted by the encryption processor 153a. The data stored in the encrypted data memory 154a is segmented into units of 13 bits from the beginning, and the 13-bit data segments are input to the exclusive-OR operators 155a, 155b, 155c, . . . , 155i, respectively.

Each of the exclusive-OR operators 155a, 155b, 155c, . . . , 155i derives an exclusive OR of the corresponding 13-bit data input from the encrypted data memory 154a and the corresponding 13-bit data input from the character code encoder 151a. Then, the exclusive-OR operators 155a, 155b, 155c, . . . , 155i transfer their operation results to the character code generator 156a.

The character code generator 156a looks up the conversion table 133a and converts the operation results input from the respective exclusive-OR operators 155a, 155b, 155c, . . . , 155i to respective character codes.

With the decryptor 150a configured as described above, when ciphertext is input, the input text is decrypted in such a manner that nine characters are processed in parallel. The parallel processing serves to increase the processing speed.

Exemplary Applications:

In the conversion table 133, 133a, an exception code may be set with respect to an optional character code. The exception code is a flag specifying that the corresponding character code should not be encrypted. The character code associated with the exception code is not encoded by the character code encoder 141, 151, 141a, 151a and is transferred directly to the character code generator 146, 156, 146a, 156a.

In the character code generator 146, 156, 146a, 156a, the character code associated with the exception code is included directly in ciphertext (at the time of decryption, in plaintext). At this time, the character code which is associated with the exception code and thus is not encoded is inserted in the encrypted or decrypted character codes such that the order of the character codes is identical with that of the corresponding character codes before the encryption or the decryption.

The use of the exception code permits a terminator character string etc. of the escape sequences to be included directly in ciphertext without being encrypted.

Also, the character code associated with the exception code may be excluded from the encryption or decryption output. In this case, when the character code associated with the exception code is input, the character code encoder 141, 151, 141a, 151a removes the character code. In cases where the terminator character string or the like is unnecessary, for example, the corresponding character code can be excluded from the processing result.

Further, the character code encoder 141, 151, 141a, 151a and the character code generator 146, 156, 146a, 156a may be adapted to look up respective different conversion tables. In the case of encrypting (or decrypting) characters of EUC into characters of UNICODE, for example, the character code encoder 141, 151, 141a, 151a looks up an EUC-based conversion table whereas the character code generator 146, 156, 146a, 156a looks up a UNICODE-based conversion table.

Where multiple conversion tables are used, it is necessary that characters, the character codes of which vary depending on the character coding scheme should be encoded into respective identical numerical values regardless of which conversion table is used. For example, in the case of encoding a character code corresponding to “A,” the character code needs to be encoded into a specific numerical value without regard to the character coding scheme.

In the first and second embodiments described above, the encryption and decryption processes are performed by the server 100, but may alternatively be performed by the client 21. In this case, the initial value memory, the symmetric key memory, the conversion table, the encryptor and the decryptor are provided in the client 21.

Further, the encryption of plaintext and the decryption of ciphertext may be carried out by separate computers. In this case, the computer for encrypting plaintext is provided with the initial value memory, the symmetric key memory, the conversion table and the encryptor, whereas the computer for decrypting ciphertext is provided with the initial value memory, the symmetric key memory, the conversion table and the decryptor. The initial value memories and the symmetric key memories of these two computers should respectively hold identical data. Also, the conversion table which is looked up by the character code generator of the computer for encrypting plaintext should be identical in content with the conversion table which is looked up by the character code encoder of the computer for decrypting ciphertext.

As the encryption technique, public key encryption technique may be employed instead of symmetric key encryption technique. In this case, the key data used for encryption and that used for decryption have different values.

Also, in the above example, the CFB mode is used as the mode of encryption using a shift register. Any desired block encryption mode may, however, be used insofar as the encrypted values can be made to have a chained relationship such that the encrypted value generated by the previous encryption is used for the next encryption. Such a chained relationship makes it possible to encrypt a series of identical characters into a series of varying characters. Block encryption modes providing such a chained relationship include OFB (Output Feed Back) mode and CBC (Cipher Block Chaining) mode.

The processing function described above can be performed by a computer. In this case, a program is prepared in which is described the process for performing the function of the server. The program is executed by a computer, whereupon the aforementioned processing function is accomplished by the computer. The program describing the process may be recorded on computer-readable recording media. As such computer-readable recording media, magnetic recording devices, optical discs, magneto-optical recording media, semiconductor memories, etc. may be used.

Magnetic recording devices include a hard disk drive (HDD), a flexible disk (FD), a magnetic tape, etc. Optical discs include a DVD (Digital Versatile Disc), a DVD-RAM (Random Access Memory), a CD-ROM (Compact Disc Read Only Memory), a CD-R (Recordable)/RW (ReWritable), etc.

Magneto-optical recording media include an MO (Magneto-Optical disk) etc.

To market the program, portable recording media, such as DVDs and CD-ROMs, on which the program is recorded may be put on sale. Alternatively, the program may be stored in the storage device of a server computer and may be transferred from the server computer to other computers via a network.

A computer which is to execute the program stores in its storage device the program recorded on a portable recording medium or transferred from the server computer, for example. Then, the computer loads the program from its storage device and performs the process in accordance with the program. The computer may load the program directly from the portable recording medium to perform the process in accordance with the program. Also, as the program is transferred from the server computer, the computer may sequentially execute the process in accordance with the received program.

The present invention is not limited to the foregoing embodiments alone and may be modified in various ways without departing from the scope of the invention.

According to the present invention, character codes are encoded into respective numerical values, each of which is then encrypted by using a previously encrypted value, and the encrypted values are converted again to character codes. Thus, each character code corresponding to one character is encrypted into a character code also corresponding to one character, so that plaintext can be encrypted without changing the number of characters. Moreover, a series of identical characters appearing in plaintext can be encrypted into a series of varying characters, thus ensuring high security.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium recording a character code encryption program for encrypting character codes,
wherein the character code encryption program causes a computer to function as:
a conversion table memory for storing at least one conversion table in which are registered correspondences permitting reciprocal conversion between character codes of a predetermined character coding scheme and respective numerical values of predetermined bit length;
a plaintext encoder, responsive to input of plaintext constituted by at least one character code, for looking up the conversion table associated with the character coding scheme of character codes constituting the plaintext, to convert the character codes included in the plaintext to corresponding numerical values;
an encryptor for successively acquiring the numerical values of the individual character codes, obtained by the plaintext encoder, to encrypt a first numerical value into an encrypted value with an identical number of bits, by using an initial value set in a register, and then to encrypt second and subsequent numerical values by alternately repeating updating of the register value by using at least part of the encrypted value and encryption of the numerical value by using the pdated register value; and
a character code generator for looking up the conversion table associated with a predetermined character coding scheme, to convert the individual encrypted values obtained by the encryptor to corresponding character codes.

2. The computer-readable recording medium according to claim 1, wherein the encryptor updates the register value by shifting the register value in a predetermined direction and storing at least part of the encrypted value in a free storage area freed by the shifting.

3. The computer-readable recording medium according to claim 1, wherein the conversion table memory stores an exception code specifying that an optional character code should not be encrypted,
wherein the plaintext encoder avoids encoding the character code specified by the exception code, and
wherein the character code generator inserts the character code not encoded by the plaintext encoder, into character codes obtained by conversion of the encrypted values such that order of the character codes is identical with that of the corresponding character codes constituting the plaintext.

4. The computer-readable recording medium according to claim 1, wherein the conversion table memory stores an exception code specifying that an optional character code should not be encrypted, and
wherein the plaintext encoder removes the character code specified by the exception code.

5. The computer-readable recording medium according to claim 1, wherein the encryptor encrypts the numerical values by parallel processing when the initial value is set in the register and each time the register value is updated.

6. The computer-readable recording medium according to claim 1,
wherein the character code encryption program further causes the computer to function as:
a ciphertext encoder, responsive to input of ciphertext constituted by at least one character code, for looking up the conversion table associated with the character coding scheme of character codes constituting the ciphertext, to convert the character codes included in the ciphertext to corresponding encrypted values;
a decryptor for successively acquiring the encrypted values of the individual character codes, obtained by the ciphertext encoder, to decrypt a first encrypted value into a numerical value with an identical number of bits by using the initial value set in the register, and then to decrypt second and subsequent encrypted values by alternately repeating updating of the register value by using at least part of the encrypted value which has been decrypted and decryption of the encrypted value by using the updated register value; and
a character code regenerator for looking up the conversion table associated with the predetermined character coding scheme, to convert the individual numerical values, obtained by the decryptor, to corresponding character codes.

7. A character code encryption method for encrypting character codes through processing of a computer, comprising the steps of:
previously storing, in conversion table memory, at least one conversion table in which are registered correspondences permitting reciprocal conversion between character codes of a predetermined character coding scheme and respective numerical values of predetermined bit length, and looking up, in response to input of plaintext constituted by at least one character code, the conversion table associated with the character coding scheme of character codes constituting the plaintext, to convert the character codes included in the plaintext to corresponding numerical values;
successively acquiring the numerical values of the individual character codes, obtained by the encoding, to encrypt a first numerical value into an encrypted value with an identical number of bits, by using an initial value set in a register, and then to encrypt second and subsequent numerical values by alternately repeating updating of the register value by using at least part of the encrypted value and encryption of the numerical value by using the updated register value; and
looking up the conversion table associated with a predetermined character coding scheme, to convert the individual encrypted values obtained by the encryption to corresponding character codes.

8. A character code encryption device for encrypting character codes, comprising:
a conversion table memory for storing at least one conversion table in which are registered correspondences permitting reciprocal conversion between character codes of a predetermined character coding scheme and respective numerical values of predetermined bit length;
a plaintext encoder, responsive to input of plaintext constituted by at least one character code, for looking up the conversion table associated with the character coding scheme of character codes constituting the plaintext, to convert the character codes included in the plaintext to corresponding numerical values;
an encryptor for successively acquiring the numerical values of the individual character codes, obtained by the plaintext encoder, to encrypt a first numerical value into an encrypted value with an identical number of bits, by using an initial value set in a register, and then to encrypt second and subsequent numerical values by alternately repeating updating of the register value by using at least part of the encrypted value and encryption of the numerical value by using the updated register value; and
a character code generator for looking up the conversion table associated with a predetermined character coding scheme, to convert the individual encrypted values obtained by the encryptor to corresponding character codes.
